(19) United States
(12) Patent Application Publication
(10) Pub. No.: US 2016/0363481 A1
(43) Pub. Date: Dec. 15, 2016

(54) SPECTROMETER AND ANALYSIS APPARATUS

(71) Applicant: SICK AG, Waldkirch/Breisgau (DE)

(72) Inventors: Julian EDLER, Emmendingen (DE); Pascal ORTWEIN, Haslach (DE); Michael OVERDICK, Emmendingen (DE); Markus DAMBACHER, Freiburg (DE); Rolf DISCH, Eichstetten (DE)

(21) Appl. No.: 15/176,275

(22) Filed: Jun. 8, 2016

(30) Foreign Application Priority Data
Jun. 11, 2015 (DE) 10 2015 109 340.5

(51) Int. Cl. G01J 3/02; G01N 21/31

(52) U.S. Cl. CPC G01J 3/0205; G01N 21/31; G01N 2201/068

(57) ABSTRACT

The invention relates to a spectrometer having a plurality of dispersive optical elements arranged such that electromagnetic radiation entering into the spectrometer is incident on the dispersive optical elements to be split spectrally there; the dispersive optical elements differ from one another with respect to their spatial positions and/or their spectral splitting capabilities; the dispersive optical elements are arranged such that the spectra generated by the respective dispersive optical elements by the splitting of the electromagnetic radiation extend in the same direction and are adjacent to one another transversely to this direction of the spectral splitting; and a detector resolving spatially in two dimensions and being located in the optical path of the split electromagnetic radiation for the detection of at least some respective part sections of the spectra. The invention furthermore relates to an analysis apparatus for determining absorption properties of solid, liquid or gaseous substances or substance mixtures.

The present invention relates to a spectrometer having an arrangement for the spectral splitting of electromagnetic radiation entering into the spectrometer; and having a detector which is located in the optical path of the split electromagnetic radiation for the detection of the split electromagnetic radiation.

The invention furthermore relates to an analysis apparatus having such a spectrometer.

Spectrometers are used, for example, in gas analyzers to determine the concentration or presence of various gases within an optical measurement path. For this purpose, light is sent through an optical measurement path in which the measurement gases or measurement gas components are to be detected and/or their concentration is to be determined. The term “light” is used in the present text for electromagnetic radiation in general and optionally also comprises, in addition to the visible wavelength range, also the infrared or ultraviolet wavelength range.

In such a gas analyzer, the measurement light irradiates the optical measurement path in a manner known per se and is in this respect absorbed in dependence on the wavelength by the respective gas components present. The light is e.g. incident on an entry aperture of a spectrometer after this wavelength-dependent absorption and is incident from there, for example, on a diffraction grating of the spectrometer at which it is differently diffracted in dependence on the wavelength. The light thus diffracted in dependence on the wavelength is imaged onto a detector, with the position of the point of incidence depending on the wavelength.

A spectrum results in this respect in a manner known per se from which it can be read which wavelengths have been absorbed more or less in order thus to be able to draw a conclusion on the presence and/or concentration of individual gas components. The term “gas” is also used here for the individual gas components which may be present together in the optical measurement path.

Such spectrometers cannot only be used in gas analyzers, but rather generally in analysis apparatus in which gaseous, liquid and/or solid substances or substance mixtures can be analyzed while taking account of their absorption properties.

Detector arrays are used as detectors, for example, in which a plurality of photodiodes are arranged next to one another on a component in the direction of the spectral splitting by the diffraction grating. Alternatively, elongated PSD (position-sensitive device) elements can also be used as detector arrays.

The detector array must be selected such that, on the one hand, the spectral region Δλ of interest is imaged on the total array and, on the other hand, the resolution of the spectrum δλ is high enough in order also to be able to evaluate fine spectral structures with sufficient accuracy.

Both finely resolved spectral structures and coarsely resolved spectral structures are frequently located in a spectral range to be evaluated. If this spectral range Δλ to be analyzed is large and if at the same time a sufficient resolution of the fine spectral structures δλ is required, a detector array having a high number of light-sensitive elements has to be used. Since the range in which the spectral lines are imaged with ideal Sharpness is located on a sphere as a rule, the problem is also present on the use of a very long, typically planar detector array that the total spectral range Δλ cannot be detected with the required sharpness. A solution to this problem by the use of a curved detector array adapted to the sphere is already problematic for technical reasons. The use of a holographic flat-field grating which images a limited portion of the spectral range sharply on a plane is expensive and is also not possible over a wide spectral range.

Customary spectrometers therefore typically represent a compromise between the spectral range Δλ to be detected and the achievable spectral resolution R.

It is the object of the invention to provide a spectrometer and an analysis apparatus which can detect a large spectral range Δλ in an inexpensive manner and which simultaneously have a high spectral resolution δλ.

This object is satisfied by a spectrometer having the features of claim 1 and by an analysis apparatus having the features of claim 15.

A spectrometer in accordance with the invention comprises a plurality of dispersive optical elements which are arranged such that electromagnetic radiation which enters into the spectrometer is incident on the dispersive optical elements to be spectrally split there. The dispersive optical elements differ from one another with respect to their spatial positions and/or their spectral resolution capabilities. The dispersive optical elements are arranged such that the spectra generated by the respective dispersive optical elements by the splitting of the electromagnetic radiation extend in the same direction and are adjacent to one another transversely to this direction. A detector resolving spatially in two dimensions is located for the detection of at least respective part sections of the spectra in the optical path of the split electromagnetic radiation.

The electromagnetic radiation can be coupled into the spectrometer in different manners. An entry aperture is preferably provided, particularly preferably an entry gap, which allows the coupling in of the electromagnetic radiation to be analyzed. Such an entry gap can be implemented simply and nevertheless precisely. Alternatively, a fiber coupling in can also take place with the aid of an optical fiber which couples the electromagnetic radiation to be analyzed into the spectrometer. Other embodiments can e.g. use a broadband laser (e.g. a white light laser) as the light source which provides a spatially restricted or collimated beam and enters into the spectrometer (e.g. after passing through the optical measurement path).

The dispersive optical elements can be selected from a group which comprises, for example, dispersion prisms and optical gratings, in particular transmission gratings and reflection gratings. As a rule, all the dispersive optical elements are elements of the same type of this group, but with it not being precluded also to select different elements of this group.

The spectral splitting capability of the dispersive optical elements can be characterized, for example, by the relationship between the spacing of two spectral lines of a specific wavelength in an image of the spectrum and the spacing between this image and the dispersive optical element. The spectral splitting capability is determined, for example with an optical grating or diffraction grating, by its grating constant and with a dispersion prism by its refractive index.

The detector resolving spatially in two dimensions (2D detector) is, for example, in a manner known per se a two-dimensional detector array (e.g. in CMOS technology, MOS technology or CCD technology) having a plurality of light-sensitive elements arranged in a plurality of rows and a plurality of columns. In accordance with an advantageous embodiment, the detector can be provided in full or in part with a scintillator coating, in particular a UV-sensitive scintillator coating.

It is possible using the spectrometer in accordance with the invention simultaneously to detect a plurality of selected part sections of the spectral range of the electromagnetic radiation to be analyzed, but also the total spectral range, by means of the detector spatially resolving in two dimensions by a suitable choice of the dispersive optical elements with respect to their spectral splitting capability and/or by their suitable spatial positioning and/or alignment and to generate a corresponding image electronically which can be processed and subsequently evaluated as required with the aid of an evaluation unit known per se. Not only the wavelength ranges, but also the spectral resolution δλ can thus be selected within wide limits.

The detector is preferably aligned relative to the dispersive optical elements such that the direction of the spectral splitting of the spectra extends in parallel with the rows or columns of the detector.

For example, a spectrum which comprises the total spectral range of the electromagnetic radiation to be analyzed can be detected with a relatively small resolution over a part range of the detector, while other part ranges of the detector record a plurality of different part sections or excerpts from the total spectrum with a relatively high resolution. The part sections can be formed, but do not have to be formed, by directly mutually adjacent wavelength ranges. The detection of partly overlapping part sections or wavelength ranges is also possible. Wavelength ranges which do not have any spectral structures relative to an analysis can be masked or discarded by non-detection.

The splitting of the electromagnetic radiation to be analyzed with the aid of a plurality of dispersive optical elements and the subsequent detection by means of an inexpensive 2D detector in accordance with the present invention allow an efficient optimization of the spectral resolution of the spectrometer without the spectral range Δλ hereby being unnecessarily restricted and vice versa.

In accordance with an advantageous embodiment of the invention, the dispersive optical elements additionally have imaging properties. To ensure a sharp imaging of the spectra on the detector, spectrometers additionally have in a manner known per se imaging elements in the optical path between the dispersive optical element or elements. Due to the use of dispersive optical elements having imaging properties, these imaging elements can be dispensed with or their number can at least be reduced. The imaging elements or also the imaging elements used additionally or also alternatively or to the dispersive optical elements having imaging properties can, for example, comprise lenses or concave mirrors, in particular also cylindrical lenses or simply curved concave mirrors.

It is of advantage in this connection if the dispersive optical elements are configured as imaging reflection gratings, with in particular at least some of the dispersive optical elements additionally also differing from one another with respect to the focal length. Imaging reflection gratings combine the function of an optical grating and of a concave mirror, with the imaging reflection grating being able to be both spherically curved and simply curved. When dispersive optical elements having different focal lengths are used, a respective dispersive optical element can be optimized for a specific spectral range both with respect to the spectral resolution δλ and with respect to the sharp imaging of this spectral range on the detector.

In accordance with a further advantageous embodiment of the invention, the dispersive optical elements are configured as a single-piece dispersive element which has a plurality of part regions which differ from one another with respect to their spatial orientation and/or their spectral splitting capability and which thus form the named dispersive optical elements. An example for such a dispersive element is a diffraction grating, for example in the form of a film which has a plurality of regions with different grating constants. Such a single-piece dispersive element represents a particularly inexpensive solution.

A further advantageous embodiment is characterized in that at least one of the dispersive optical elements is arranged adjustably with respect to its spatial position such that at least that wavelength range of the part section of the spectrum generated by the adjustably arranged dispersive optical element which is incident on the detector is variable. An adaptation of the spectrometer to the substances or to the substance mixture to be examined can take place by an adjustment of the spatial position, for example by a tilting of the dispersive optical element or elements, in that a respective wavelength range of interest can be individually selected.

The adjustability can furthermore also be utilized for adjustment purposes. If not only the orientation, but also the spatial position, in particular the spacing from the detector, can be adjusted, it is not only possible to shift the wavelength range to be detected, but also to vary its size. The adjustment can take place manually or by a motor. A control unit can in particular be provided which carries out an automatic adjustment, for example while using suitable calibration substances.

In accordance with a further advantageous embodiment, at least one of the dispersive optical elements has a respective deflection element associated with it which is arranged adjustably such that at least the wavelength range of the part section of the spectrum generated by the associated dispersive optical element which is incident on the detector is variable. Unlike the above-described embodiment, it is not the dispersive optical element which is adjusted to vary the wavelength range, but rather the deflection element. Suitable deflection elements are, for example, mirrors or mirror arrays, with an embodiment as an imaging deflection element, e.g. as a concave mirror, also being possible.

In this case and/or generally with further embodiments in which a variable positioning of the spectrum or spectra on the detector is not necessary or is not desired, the dispersive optical element or elements can be arranged at a fixed or fixedly set spatial position, in particular at a fixed or a fixedly set relative tilt with respect to one another.

In general the two above-named embodiments can also comprise an adjustment of the position of the spectrum or spectra on the detector in a direction transversely to the direction of the spectral splitting with respect to the variability of the part section of the spectrum incident on the detector. Furthermore, both adjustment possibilities can also be combined with one another.

In a further advantageous embodiment of the invention, the dispersive optical elements are designed such that at least some of the part sections of the spectra incident on the detector can have different extents transversely to the direction of the spectral splitting. This can be implemented, for example, by the use of dispersive optical elements in the form of differently wide diffraction gratings, with the width relating to the extent of the grating transversely to the direction of the spectral splitting. Spectral ranges in which a low radiation intensity is present can thus be split using wider gratings than those spectral ranges which have a high intensity. Since the spectra with lower intensity irradiate a larger surface of the detector in this manner than those with a higher intensity, an improved signal-to-noise ratio can also be achieved at smaller intensities, for example by summing of those signals transversely to the splitting direction which emanate from a diffraction grating.

A spectrometer in accordance with a further advantageous embodiment furthermore comprises an evaluation unit which is connected to the detector and which is configured to correct one or more aberrations of the detected part sections of the spectra which occur in the optical path, wherein the aberrations to be corrected in particular comprise those aberrations which have the effect that the extent of the spectra is not linear and/or that a straight line incident on the dispersive optical elements is incident on the detector as a curved line. Such aberrations can be due, for example, to geometrical and/or chromatic aberrations, adjustment errors, component defects or the like. Ultimately, the spectral lines in the individual spectra represent images of e.g. the entry gap. If these spectral lines are no longer imaged as straight lines on the detector, this makes the later evaluation more difficult. It is thus helpful for the later evaluation of an image taken by the detector, in particular for the summing of those pixels which were each produced by electromagnetic radiation having the same wavelength if these pixels are all in the same row or in the same column. The spectral lines in a correspondingly corrected image thus appear as straight lines extending horizontally or vertically. The aberrations to be corrected can in particular also comprise time-variable aberrations, in particular also distortions, which can be due, for example, to time changes of the optical properties of the dispersive optical elements, e.g. changes of the grating constant, and/or to time changes of the optical properties of further imaging elements which may be provided in the optical path such as collimators or imaging lenses and/or to relative position changes of these elements. Such time-variable aberrations can in particular be caused by thermally induced drift and/or by other mechanical influences and can become noticeable, for example, by a wobble, displacement and/or rotation of the images of the spectra on the detector.

As stated above, a spectrometer in accordance with the invention can in particular be used in an analysis apparatus for determining absorption properties of solid, liquid or gaseous substances or substance mixtures such as is the subject of claim 15.

Such an analysis apparatus has a spectrometer in accordance with the invention. In addition, a source for electromagnetic radiation and an optical measurement path arranged between the source for electromagnetic radiation and the spectrometer are provided for the substances or substance mixtures to be examined using the analysis apparatus. Electromagnetic radiation from the source passes through the optical measurement path where the wavelength-dependent absorption may then take place by the substances or substance mixtures to be examined, with the absorption being able to be measured in dependence on the wavelength by the spectrometer.

The advantages of such an analysis apparatus in accordance with the invention and the special embodiments and advantageous uses result from the advantages and embodiments named above for the spectrometer in accordance with the invention.

Further advantageous embodiments of the invention result from the dependent claims, from the description and from the drawings.

The invention will be described in the following with reference to an embodiment and to the drawings. There are shown:

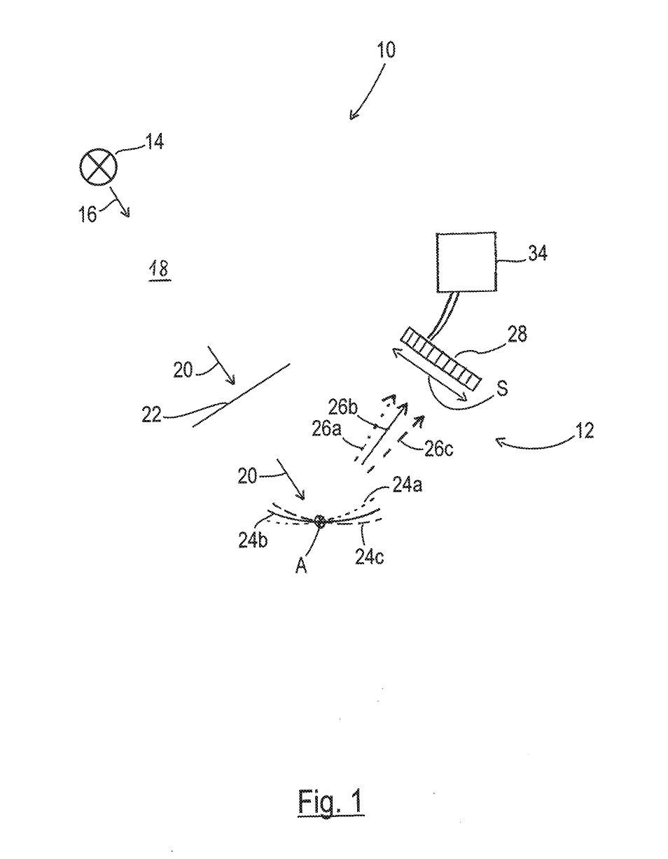

FIG. 1 an analysis apparatus in accordance with the invention with a spectrometer in accordance with the invention in a schematic representation not to scale;

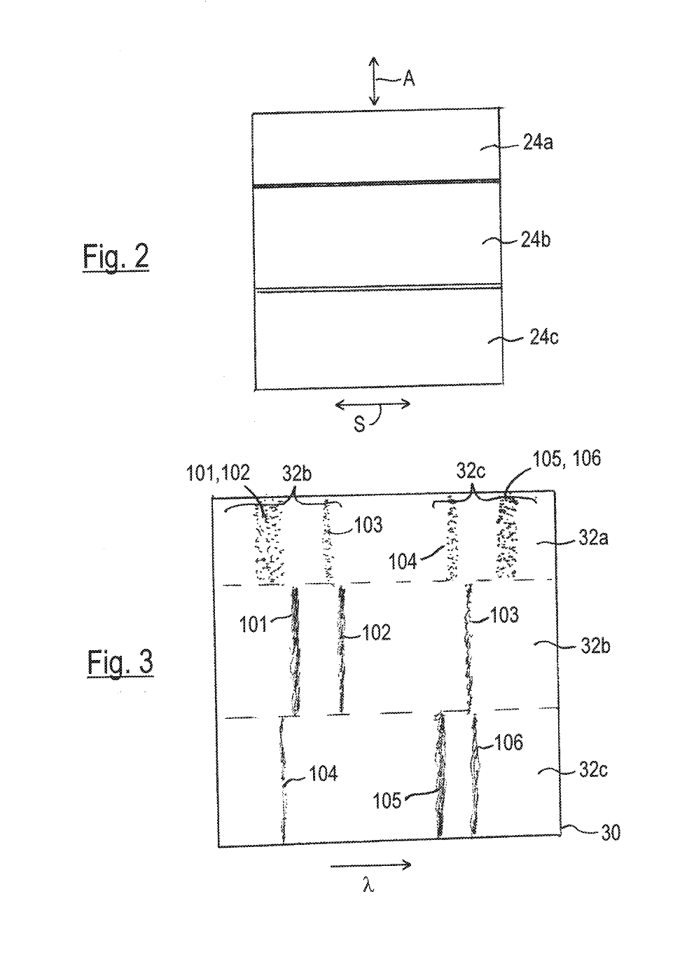

FIG. 2 a detailed view of three reflection gratings of the spectrometer of FIG. 1; and

FIG. 3 a schematic image generated by a detector of the analysis apparatus of FIG. 1 with three different spectra.

FIG. 1 shows an analysis apparatus 10 in accordance with the invention having a spectrometer 12 in accordance with the invention, a light source 14 and a measurement path 18. The spectrometer 12 comprises an entry gap 22, three simply concavely curved reflection gratings 24a, 24b, 24c and a detector 28. The spectrometer 12 can furthermore have different beam-shaping imaging elements (e.g. collimators, imaging lenses) as well as a spectrometer housing, which are not shown in FIG. 1 for reasons of clarity.

The grating constants in the shown example amount to 800 lines/mm for the reflection grating 24a, to 1750 lines/mm for the reflection grating 24b, and to 2000 lines/mm for the reflection grating 24c. As can be recognized from FIG. 2, the extent of the reflection gratings 24a to 24c is selected the same here transversely to a direction of the spectral split S in the reflection gratings 24b, 24c. The reflection grating 24a has a somewhat smaller extent than the reflection grating 24c transversely to the direction S.

As can be recognized in FIG. 1, the reflection gratings 24a to 24c are somewhat tilted with respect to one another about an axis A which extends perpendicular to the plane of the drawing and thus perpendicular to the direction of the spectral splitting S.

The light source 14 emits light 16 (as a rule from the ultraviolet, visible and/or infrared spectral range) in the direction of the measurement path 18. The substance or the substance mixture (gaseous, liquid or solid) to be examined is located there. On passing through the substance or substance mixture, the transmitted light 16 is absorbed in dependence on the wavelength.

The light 20 to be analyzed exiting the measurement path 18 enters through an entry gap 22, which extends perpendicular to the plane of the drawing, into the spectrometer 12 and is reflectively diffracted at the reflection gratings 24a to 24c and is thereby spectrally split. Respective beams of spectrally split light 26a, 26c and 26c generated by the reflection gratings 24a, 24b and 24c respectively are detected by the detector 28.

The detector 28 is a detector which resolves spatially in two dimensions and which has a plurality of light-sensitive elements arranged in rows and columns. The overlapping beams of spectrally split light 26a, 26b and 26c which may overlap only slightly impact different part regions of the detector 28 and there generate respective spectra 32a, 32b and 32c which are recorded together to form an image 30 (see FIG. 3).

The detector 28 is connected to an evaluation unit 34 which is configured to read out the light-sensitive elements, to generate the image 30 and to determine the intensity of the detected spectrally split light 26a, 26b, 26c with spatial resolution (in the direction of the spectral splitting S) from the image 30 in order ultimately to determine which components of the light 16 emitted by the light source 14 are absorbed more or less in the measurement path 18.

The spectrum 32a generated by the reflection grating 24a represents a total or overview spectrum which comprises spectral lines 101 to 106 and extends in the representation of FIG. 3 approximately over a wavelength range from 300 nm to 900 nm. The arrow marked by λ in FIG. 3 points in the direction of increasing wavelengths. The spectral line 101 lies at approximately 400 m; the spectral line 102 at approximately 420 nm; the spectral line 103 at approximately 500 nm; the spectral line 104 at approximately 700 nm; the spectral line 105 at approximately 780 nm; and the spectral line 106 at approximately 800 nm.

The spectrum 32b generated by the reflection grating 24b corresponds to a part section of the overview spectrum 32a which comprises a substantially smaller wavelength range in comparison with the spectrum 32a, but in turn reproduces it at a higher spectral resolution δλ. Unlike in the spectrum 32a, the spectral lines 101, 102 are clearly recognizably separate from one another in the spectrum 32b.

The spectrum 32c generated by the reflection grating 24c shows a further part section of the overview spectrum 32a whose wavelength range is likewise considerably smaller than in the spectrum 32a. Since the spectral resolution δλ is also higher in the spectrum 32c than in the spectrum 32a, the spectral lines 105, 106 are clearly separate from one another, unlike in spectrum 32a.

The spectra 32b, 32c in the example shown finally represent excerpts from the spectrum 32a whose wavelength ranges in the spectrum 32a are marked by brackets which were provided with the reference numerals 32b, 32c of the corresponding spectra.

The different spectral ranges can be weighted by different amounts by differently large surfaces of the different reflection gratings 24a to 24c to optimize the signal-to-noise ratio (SNR) in different ranges. This is utilized in the present embodiment in that a smaller portion of the light is used for the overview spectrum 32a and two respectively larger portions of the light for the recording of the detailed spectra 32b, 32c. Ranges which have very weak spectral lines can thus be recorded at a higher effective averaging time.

In addition to other parameters and aspects, in particular the selected wavelength ranges, the number of gratings and their grating constants are only by way of example in the present embodiment. Different spectral ranges can thus be shown on a single detector with the same resolution or also different spectral ranges can be shown with different resolutions. Both high-resolution spectral structures of small wavelength ranges and low-resolution structures of large wavelength ranges can be recorded with one measurement.

### REFERENCE NUMERAL LIST

10 analysis apparatus
12 spectrometer
14 light source
16 emitted light
18 measurement path
20 light to be analyzed
22 entry gap
24a-24c reflection gratings
26a-26c spectrally split light
28 detector
30 image
32a-32c spectrum
34 evaluation unit
101-106 spectral line
A axis
S direction of the spectral split

1. A spectrometer comprising
a plurality of dispersive optical elements which are arranged such that electromagnetic radiation entering into the spectrometer is incident on the plurality of dispersive optical elements to be spectrally split there, wherein the plurality of dispersive optical elements differ from one another with respect to their spatial positions and/or their spectral splitting capabilities;
and wherein the plurality of dispersive optical elements are arranged such that the spectra generated by the respective one of the plurality of dispersive optical elements by the splitting of the electromagnetic radiation extend in the same direction and are adjacent to one another transversely to this direction of the spectral splitting; and
a detector which resolves spatially in two dimensions and which is located in the optical path of the split electromagnetic radiation for the detection of at least respective part sections of the spectra.

2. The spectrometer in accordance with claim 1, further comprising an entry aperture for coupling in the electromagnetic radiation (20).

3. The spectrometer in accordance with claim 2, wherein the entry aperture is an entry gap.

4. The spectrometer in accordance with claim 1, wherein the plurality of dispersive optical elements are selected from the group of members comprising dispersion prisms, optical gratings and combinations thereof.

5. The spectrometer in accordance with claim 4, wherein the optical gratings are selected from the group of members consisting of transmission gratings, reflection gratings and combinations thereof.

6. The spectrometer in accordance with claim 1, wherein the plurality of dispersive optical elements additionally have imaging properties.

7. The spectrometer in accordance with claim 6, wherein the plurality of dispersive optical elements are configured as imaging reflection gratings.

8. The spectrometer in accordance with claim 7, wherein at least some of the plurality of dispersive optical elements also additionally differ from one another with respect to the focal length.

9. The spectrometer in accordance with claim 1, wherein the plurality of dispersive optical elements are formed as a single-piece dispersive element which has a plurality of part regions which differ from one another with respect to their spatial positions and/or their spectral splitting capabilities and which thus form the named plurality of dispersive optical elements.

10. The spectrometer in accordance with claim 1, wherein at least one of the plurality of dispersive optical elements is arranged adjustably with respect to its spatial position such that at least the wavelength range of the part section incident on the detector of the spectrum generated by the adjustably arranged dispersive optical element is variable.

11. The spectrometer in accordance with claim 1, wherein at least one of the plurality of dispersive optical elements has a respective deflection element associated with it which is arranged adjustably such that at least the wavelength range of the part section incident on the detector of the spectrum generated by the associated dispersive optical element is variable.

12. The spectrometer in accordance with claim 1, wherein the plurality of dispersive optical elements are configured such that at least some of the part sections of the spectra incident on the detector have different extents transversely to the direction of the spectral splitting.

13. The spectrometer in accordance with claim 1, further comprising an evaluation unit which is connected to the detector and which is designed to correct one or more aberrations of the detected part sections of the spectra occurring in the optical path.

14. The spectrometer in accordance with claim 13, wherein the aberrations to be corrected comprise such aberrations which have the effect that the extent of the spectra is not linear and/or that a straight line incident on the plurality of dispersive optical elements impacts the detector as a curved line.

15. An analysis apparatus for determining absorption properties of solid, liquid or gaseous substances or substance mixtures comprising a spectrometer in accordance with claim 1; a source for electromagnetic radiation; and an optical measurement path arranged between the source for electromagnetic radiation and the spectrometer for the substances or substance mixtures to be examined using the analysis apparatus.
